(19) United States
(12) Patent Application Publication
(10) Pub. No.: US 2013/0255985 A1
(43) Pub. Date: Oct. 3, 2013

(54) Portable Jackhammer

(71) Applicant: Yuriy Zakuskin, Orekhov (UA)

(72) Inventor: Yuriy Zakuskin, Orekhov (UA)

(21) Appl. No.: 13/437,157

(22) Filed: Apr. 2, 2012

(51) Int. Cl. B25D 9/10

(52) U.S. Cl. 173/209

(57) ABSTRACT

A portable, self-contained jackhammer system is described. The jackhammer system can include an internal combustion engine in a jackhammer housing. The internal combustion engine can have a piston driven by the combustion of a fuel. The piston can include a first portion and a second portion, the second portion can be configured to contact a chisel disposed at a distal end of the housing. The piston can be biased by a spring disposed in the housing and surrounding the piston.

Embodiments relate generally to jackhammers, and, more particularly, to a portable jackhammer having an internal combustion engine.

Conventional jackhammers often work via expansion of compressed air in a cylinder. Thus, conventional jackhammers may require a source of compressed air.

A need may exist for a self-contained, portable jackhammer that does not require an external source of compressed air. Such a self-contained, portable jackhammer could be used in emergency situations where electricity may not be available and where it may be difficult to move an air compressor to a desired location to operate a jackhammer. Embodiments were conceived in light of the above-mentioned problems or limitations, among other things.

At least one embodiment includes a portable jackhammer system having an internal combustion engine to drive an impact piston, which contacts a chisel and allows the jackhammer to chisel material such as concrete, asphalt, rock, stone, or the like. The internal combustion engine can be constructed and adapted to operate on a fuel such as methane, butane, propane or the like.

The portable jackhammer system can include a fuel tank, an ignition system and a housing. The internal combustion engine can include a single piston that can be biased by a spring.

### BRIEF DESCRIPTION OF THE DRAWINGS

FIG. 1 is a diagram of an example self-contained, portable jackhammer system in accordance with at least one embodiment.

FIG. 2 is a diagram of an example self-contained, portable jackhammer system in an intake phase in accordance with at least one embodiment.

FIG. 3 is a diagram of an example self-contained, portable jackhammer system in a compression phase in accordance with at least one embodiment.

FIG. 4 is a diagram of an example self-contained, portable jackhammer system in an ignition phase in accordance with at least one embodiment.

FIG. 5 is a diagram of an example self-contained, portable jackhammer system in an expansion phase in accordance with at least one embodiment.

FIG. 6 is a diagram of an example self-contained, portable jackhammer system in an impact/exhaust phase in accordance with at least one embodiment.

### DETAILED DESCRIPTION

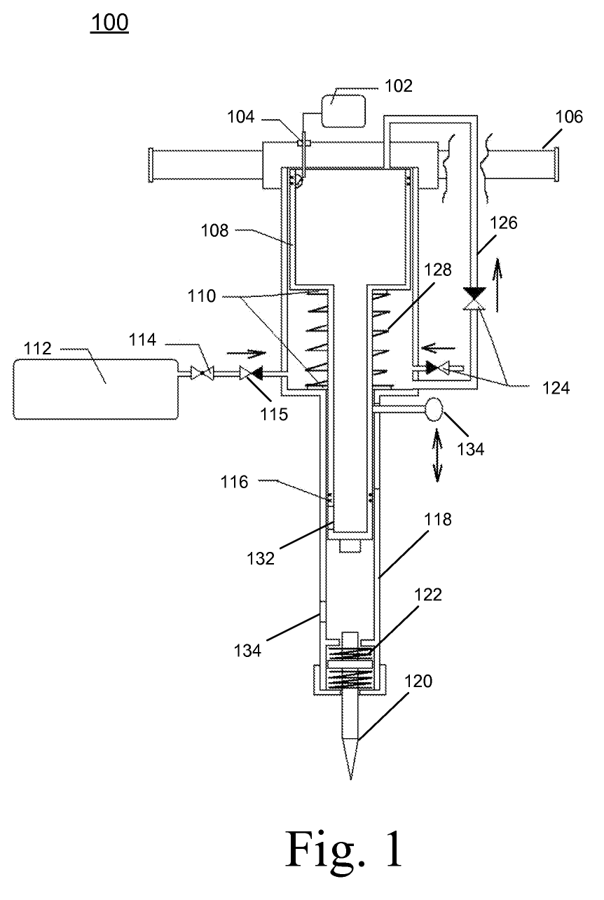

FIG. 1 shows an example self-contained, portable jackhammer system 100. The jackhammer 100 includes a sparking (or ignition) system 102, a spark plug 104, handles 106, a piston 108, heat insulation lining 110, a fuel tank 112, a flow control valve 114, a first check valve 115, sealing rings 116, a housing 118, a chisel 120, chisel biasing springs 122, check valves 124, fuel supply line 126, biasing spring 128, a housing exhaust port 130, a piston exhaust port 132 and a handle 134 connected to the piston 108.

In operation, fuel is supplied to the engine from the fuel tank 112 via a fuel line in which the flow control valve 114 and check valve 115 are placed in-line. Air is introduced to the engine via one of the one-way check valves 124.

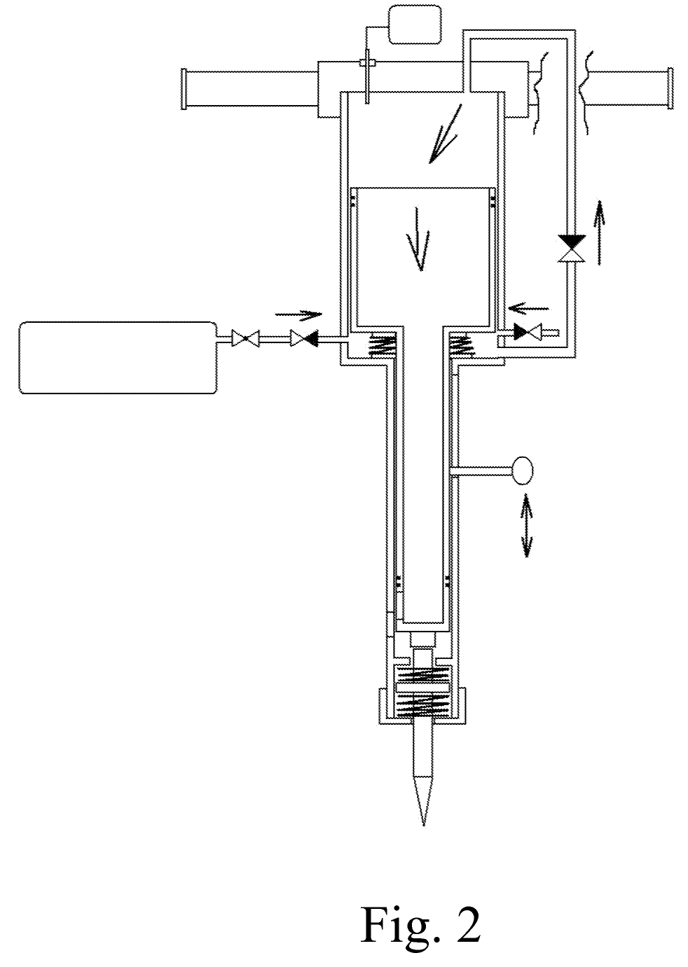

During an intake phase (shown in FIG. 2), fuel and air are mixed in a lower part of the cylinder and supplied to the upper part of the cylinder/piston via the fuel supply line 126 as the piston moves down. The fuel supply line 126 has a one-way check valve 124 in-line. The fuel/air mixture supplied by the fuel supply line 126 enters the top of the cylinder into an open area formed by the piston. It will be appreciated that the piston is configured to have an open top portion and form an opening into which the fuel/air mixture is introduced.

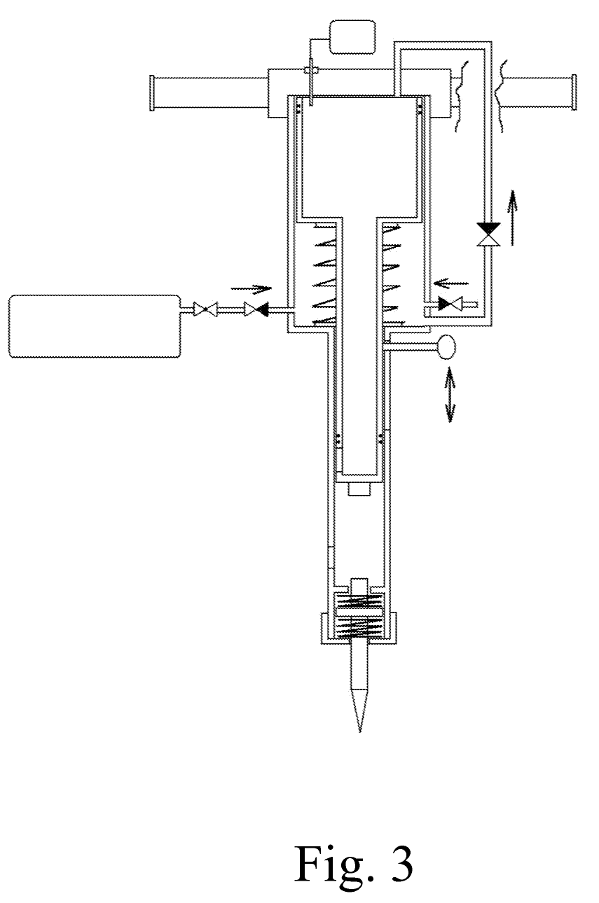

During a compression phase (shown in FIG. 3), the piston returns to a raised position either under force of the bias spring 128 or under manual force supplied through the handle 134. As the piston 108 moves upward from a lower position to an upper position, the fuel air mixture in the cylinder/piston top gets compressed.

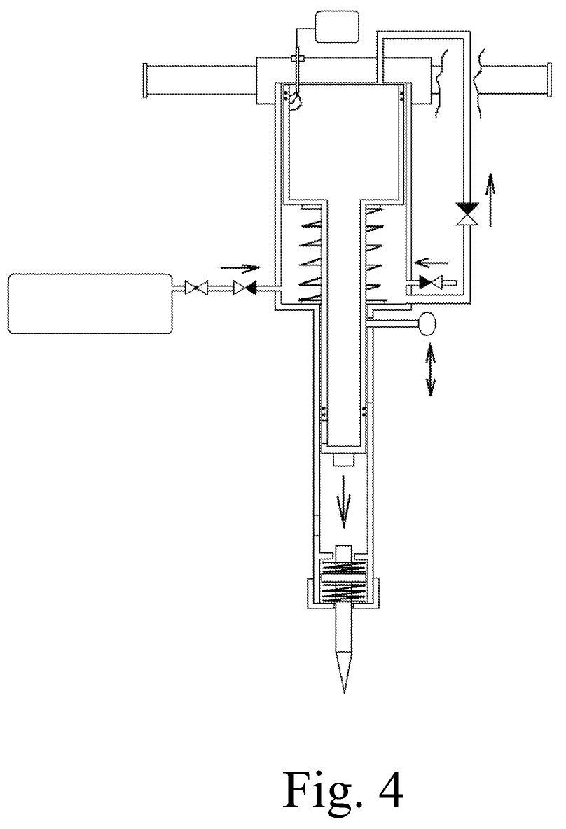

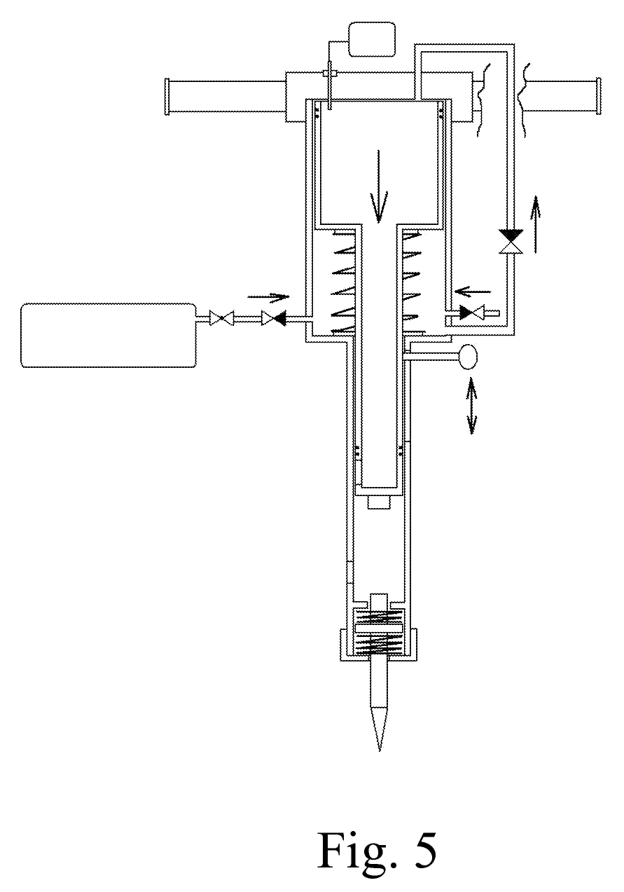

During an ignition phase (shown in FIG. 4), the spark plug 104 creates a spark that ignites the compressed fuel/air mixture in the hollow piston top. As the fuel/air mixture burns, it rapidly expands creating a force that moves the piston 108 downward (shown in FIG. 5) causing the lower end of the piston to strike the chisel 120 and permit the jackhammer to chisel or break material.

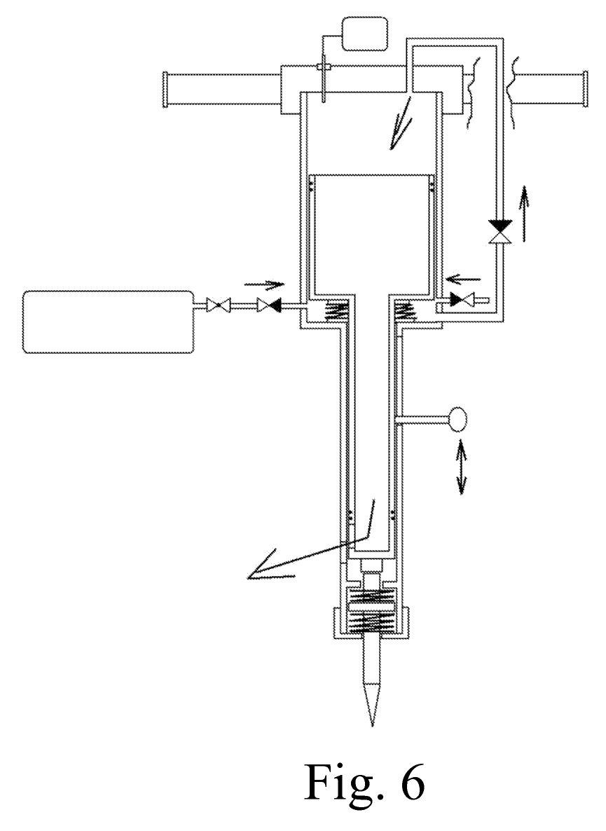

Once the piston 108 is in a lowered position (shown in FIG. 6) vapor resulting from the combustion can be released through the piston exhaust port 132 through the housing exhaust port 130.

To start the jackhammer, the handle is used to move the piston to a lowered position and it is locked into place, the flow control valve on the fuel tank line is opened to allow gas (e.g., methane, propane, butane, or the like) to flow. The lock on the handle is released, which permits the piston to move upward under the influence of the bias spring, thereby creating a vacuum in the bottom portion of the chamber, which draws in air and fuel gas.

The process of moving the handle down and locking it and then releasing it can be repeated, thereby pumping the fuel/air mixture from the bottom chamber to the cylinder/piston opening. Then, the ignition system can be activated and a spark will ignite the fuel/air mixture resulting in an explosion causing the piston moves down which the lower part of the piston contacts the chisel. During this period a next portion of fuel/air mixture is drawn in and a cycle is formed and moves in the working chamber repeats. The engine of the jackhammer works similar to that of a two-stroke engine.

To stop the jackhammer, the ignition system can be switched off.

It will be appreciated that specific dimensions of an implementation of the jackhammer described herein can vary, but overall dimensions may be similar to that of conventional pneumatic jackhammers. For example, the cylinder volume (which can include the opening in the top of the piston) can be about 500 cubic centimeters, for example.

The piston can be made from aluminum, and in the lower part can include a steel insert where the piston strikes the chisel. The case, piston and springs can be made from steel.

For prevention of fire of the fuel/air mixture between the working and bottom chamber on the connecting fuel supply line also there is a one-way valve (two can be used, one at the beginning of the line and one at the other end so it can be more reliable).

While the invention has been described in conjunction with a number of embodiments, it is evident that many alternatives, modifications and variations would be or are apparent to those of ordinary skill in the applicable arts. Accordingly, Applicant intends to embrace all such alternatives, modifications, equivalents and variations that are within the spirit and scope of the invention.

What is claimed is:

1. A portable jackhammer comprising:
an internal combustion engine disposed within a housing, the internal combustion engine having a piston, wherein the piston includes a first portion and a second portion, the second portion configured to contact a chisel disposed at a distal end of the housing, and wherein the piston is biased by a spring disposed in the housing and surrounding the piston.

2. The portable jackhammer of claim 1, further comprising a fuel tank and fuel line, the fuel line being connected between the fuel tank and the internal combustion engine.

3. The portable jackhammer of claim 2, further comprising a flow control valve and one-way valve disposed along the fuel line, the flow control valve adapted to control a flow of fuel along the fuel line and the one-way valve adapted to permit fuel to flow in only one direction from the fuel tank to the internal combustion engine.

4. The portable jackhammer of claim 1, further comprising an ignition system having a spark plug at least partially disposed within a cylinder of the internal combustion engine, a control switch and an electrical power source connected to the spark plug via the control switch, wherein when the control switch is in a first position electrical power is provided to the spark plug, and when the control switch is in a second position electrical power is prevented from being supplied to the spark plug.

5. The portable jackhammer of claim 1, further comprising a handle attached to the piston to permit the piston to be moved manually.

6. The portable jackhammer of claim 1, wherein the internal combustion engine is adapted to operate on a petroleum-based fuel.

7. The portable jackhammer of claim 1, wherein the internal combustion engine is adapted to operate on an alcohol-based fuel.

8. The portable jackhammer of claim 6, wherein the petroleum-based fuel includes one or more of methane, butane and propane.

9. The portable jackhammer of claim 1, wherein the piston is substantially round and a diameter of the first portion is larger than a diameter of the second portion.

10. The portable jackhammer of claim 4, wherein the ignition system includes a control module adapted to provide a spark signal sent to the spark plug to cause ignition based on a position of the piston.

11. A portable jackhammer comprising:
an internal combustion engine disposed within a housing, the internal combustion engine having a piston, wherein the piston includes a first portion and a second portion, the second portion configured to contact a chisel disposed at a distal end of the housing, and wherein the piston is biased by a spring disposed in the housing and surrounding the piston;
a fuel tank and fuel line, the fuel line being connected between the fuel tank and the internal combustion engine;
a flow control valve and one-way valve disposed along the fuel line, the flow control valve adapted to control a flow of fuel along the fuel line and the one-way valve adapted to permit fuel to flow in only one direction from the fuel tank to the internal combustion engine; and
an ignition system having a spark plug at least partially disposed within a cylinder of the internal combustion engine, a control switch and an electrical power source connected to the spark plug via the control switch, wherein when the control switch is in a first position electrical power is provided to the spark plug, and when the control switch is in a second position electrical power is prevented from being supplied to the spark plug.

12. A portable jackhammer comprising:
an internal combustion engine disposed within a housing, the internal combustion engine having a piston, wherein the piston includes a first portion and a second portion, the second portion configured to contact a chisel disposed at a distal end of the housing, and wherein the piston is biased by a spring disposed in the housing and surrounding the piston; and
a fuel tank adapted to supply fuel to the internal combustion engine.

13. The portable jackhammer of claim 12, wherein the fuel is a liquid fuel and the fuel tank is a liquid fuel tank.

14. The portable jackhammer of claim 12, wherein the fuel is a gaseous fuel and the fuel tank is a gaseous fuel tank.
